(19) United States
(12) Patent Application Publication
(10) Pub. No.: US 2008/0242284 A1
(43) Pub. Date: Oct. 2, 2008

(54) INTUITIVE DEVICE IDENTIFICATION

(75) Inventors: John P. Vechey, Seattle, WA (US); Jon David, Seattle, WA (US)

Correspondence Address: PERKINS COIE LLP;PATENT-SEA, P.O. BOX 1247, SEATTLE, WA, 98111-1247, US

(73) Assignee: PopCap Games, Inc., Seattle, WA (US)

(21) Appl. No.: 11/692,018

(22) Filed: Mar. 27, 2007

(51) Int. Cl. H04L 29/00

(52) U.S. Cl. 455/415

(57) ABSTRACT

A method and system for making it easy for users to identify their mobile device and the applications available for their device is provided, referred to as a device identification system. The device identification system simplifies the process of determining the device a user is using and the applications available for that device. Users are generally much more familiar with their device's features than they are with information such as the model number. Thus, the device identification system makes it easy for users to determine their device type by asking them questions to which they are likely to know the answer. Other features and alternatives are described.

### BACKGROUND

A mobile game is a video or computer game played on a mobile phone, smart phone, personal digital assistant (PDA), handheld computer, or other portable device. Users usually download mobile games via the mobile operator's radio network, but in some cases, games are loaded into the mobile devices by the device manufacturer or phone carrier when purchased, or via infrared connection, Bluetooth, Universal Serial Bus (USB), or memory card. Mobile operators often tightly control the content (e.g., games, applications, and ring tones) available on their network. Mobile operators may have concerns about the security and support issues of executable code running on user's devices, and may want to control the revenue generated by restricting the sources of content.

Game makers develop mobile games using platforms and technologies such as Windows Mobile, Palm OS, Symbian OS, Macromedia's Flash Lite, DoCoMo's DoJa, Sun's Java 2 Micro Edition (J2ME), Qualcomm's BREW (Binary Runtime for Wireless), WIPI, and Infusio's Execution Environment (ExEn). Java was initially the most common platform for mobile games; however, its performance limitations have led to the adoption of various native binary formats for more sophisticated games. Game makers must often make many different builds of a game to target each of the available platforms. Often the game maker does not have time to target every platform, so the game maker may limit the game to a few of the most popular platforms. In addition, some platforms have hardware limitations that do not accommodate a particular game. Even when a game build is available for a particular platform, a carrier may choose not to support that game, so the game may be unavailable to a particular user of that carrier. As a result, it can be hard to determine what games are available for a specific device. Even if the user knows the exact name of a game they want, users can spend hours trying to find whether their mobile operator is selling the game in their country.

Another problem is that users often do not know basic model information about their mobile device, such as the manufacturer and model number. Many sites that provide mobile games require that a user select the manufacturer and model number of their device to determine which applications are available. Some devices do not display the model information on the device, and require that the user remove a battery cover or perform other disassembly to discover the model of the device. Without knowing the model information, a site may present the user with hundreds of pictures of similar looking phones and ask the user to select their phone. Users get discouraged by the time wasted identifying their phone, particular if the process results in few or no games being available once the site has identified the user's device.

There is a need for a system that overcomes the above problems, as well as one that provides additional benefits.

### BRIEF DESCRIPTION OF THE DRAWINGS

FIG. 1 is a block diagram that illustrates a suitable computing system for a mobile device or device, used to search for content.

FIG. 2 is a block diagram that illustrates a typical computing environment for a website employing a device identification system.

FIG. 3 is a block diagram that illustrates the components of the device identification system.

FIGS. 4-12 illustrate display pages produced by a user interface component of the device identification system.

FIG. 13 is a flow diagram that illustrates the processing of the components of the system to determine the type of a user's device.

FIG. 14 is a flow diagram that illustrates the processing of a select query component of the device identification system.

### DETAILED DESCRIPTION

The headings provided herein are for convenience only and do not necessarily affect the scope or meaning of the claimed invention.

### Overview

A method and system for making it easy for users to identify their mobile device and the applications available for their device is provided, referred to as a device identification system. The device identification system simplifies the process of determining the device a user is using and the applications available for that device. The device identification system displays one or more queries to the user that describe distinguishing characteristics of multiple devices. The device identification system selects the queries in such a way that the average user is likely to be able to easily determine the answer. For example, the device identification system may ask the user whether the user's device is a flip or slider phone. The device identification system receives responses to the queries from the user, and determines the type of the user's device based on the responses received.

For example, if the user indicates that his device is a flip phone, then the device identification system may narrow down the types of device that the user may have and ask the user subsequent questions until only one device or a handful of devices match the user's responses. Then, the system may present the device or devices to the user for confirmation that the device identification system has identified the correct device. Based on the determined device, the device identification system presents the user with information related to the determined device. For example, the device identification system may present the user with information about downloading a particular game that is available for the user's device. Users are generally much more familiar with their device's features than they are with information such as the model number. Thus, the device identification system makes it easy for users to determine their device type by asking them questions to which they are likely to know the answer.

In addition, the device identification system may provide the user real-time feedback as the user responds to queries to indicate that the user is making progress towards finding applications for her device. Once the device identification system identifies a user's particular device, the device identification system may store information about the type of device as the user navigates a web site, and between visits to the web site. The device identification system may also provide cross-platform up selling opportunities by offering applications compatible with the user's mobile device when the user purchases applications for other devices (e.g., a desktop computer).

The following description describes the invention with respect to various examples or embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### Computing Environment

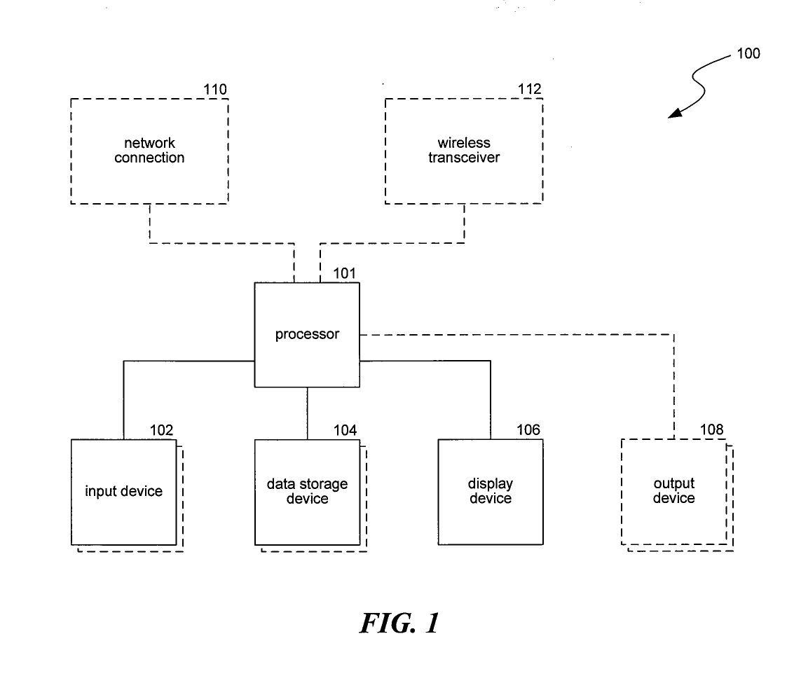

Unless described otherwise below, aspects of the invention may be practiced with conventional systems. Thus, the construction and operation of the various blocks shown in FIG. 1 may be of conventional design, and need not be described in further detail herein to make and use the invention, because those skilled in the relevant art will understand such blocks. One skilled in the relevant art can readily make any modifications necessary to the blocks in FIG. 1 (or other embodiments or figures) based on the detailed description provided herein.

FIG. 1 is a block diagram that illustrates one example of a suitable computing system for a mobile device or device used to search for content. The computing system 100 may include one or more processors 101, one or more input devices 102, one or more data storage devices 104, a display device 106, and one or more output devices 108. The computing system 100 may also include hardware for connecting to other computer systems, such as a network connection 110 and/or wireless transceiver 112. The input devices 102 may include a keyboard, keypad, mouse, tablet, microphone, and so forth. The data storage devices 104 may include a hard drive, optical disk drive, USB flash drive, storage area network (SAN) (or other network accessible storage), memory card, and so forth. The data storage devices 104 may contain computer-readable media encoded with instructions for performing one or more of the methods described herein.

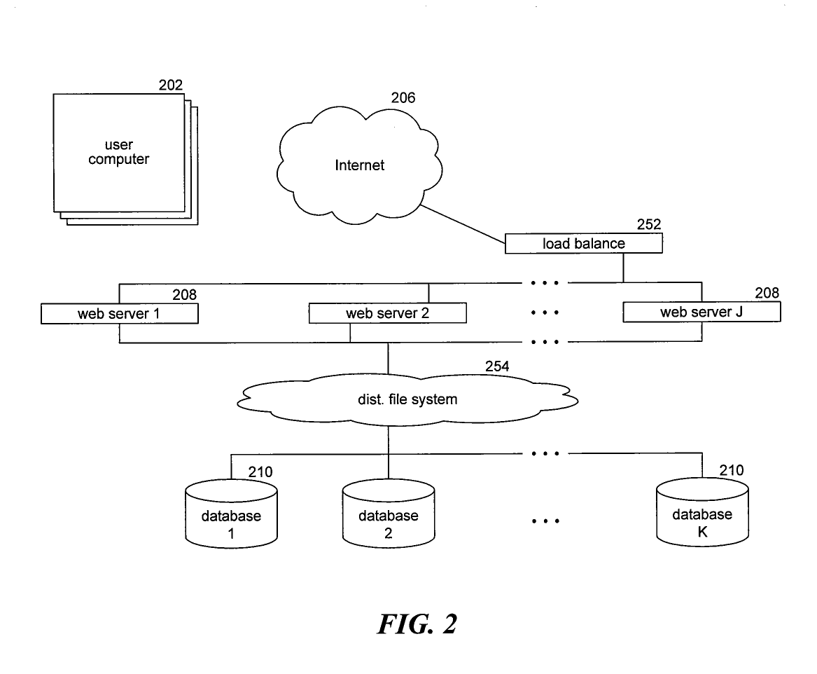

FIG. 2 is a block diagram that illustrates a typical computing environment for a website employing the device identification system. A user's computer 202 includes a browser for viewing a web page. The user's computer 202 is connected to a network such as the Internet 206, through which the user's computer 202 accesses a website 250. The website 250 may include a load balancer 252, one or more web servers 208, a distributed file system 254, and one or more databases 210. The load balancer 252 ensures that user requests are distributed among the various web servers 208. The databases 210 store the web page content offered by the website 250, and other information such as previously detected types of user devices, applications compatible with each device, and so forth. The web servers 208 access the databases 210 and provide the stored web page content in response to received user requests.

FIGS. 1-2 and the discussion herein provide a brief, general description of a suitable computing environment in which the invention can be implemented. Although not required, aspects of the invention are described in the general context of computer-executable instructions, such as routines executed by a general-purpose computer, e.g., a server computer, wireless device, or personal computer. Those skilled in the relevant art will appreciate that the invention can be practiced with other communications, data processing, or computer system configurations, including: Internet appliances, hand-held devices (including PDAs), wearable computers, all manner of cellular or mobile phones, multi-processor systems, microprocessor-based or programmable consumer electronics, set-top boxes, network PCs, mini-computers, mainframe computers, and the like. Indeed, the terms “computer” and “mobile device” are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

### Device Identification

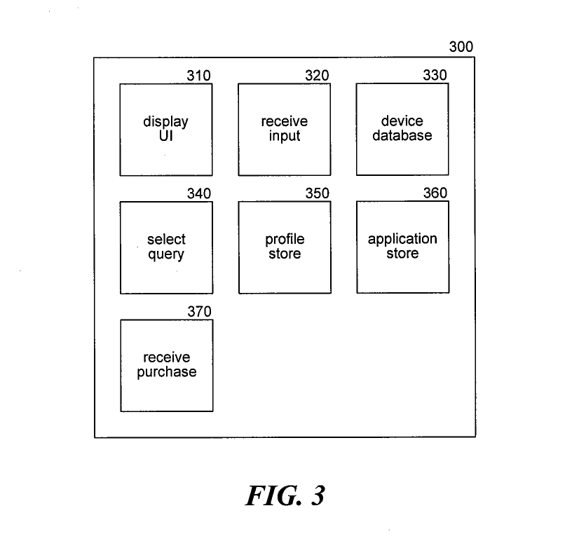

FIG. 3 is a block diagram that illustrates one example of the components of the device identification system. The device identification system 300 includes a display user interface component 310, a receive input component 320, a device database component 330, a select query component 340, a profile store component 350, an application store component 360, and a receive purchase component 370. The display user interface component displays an interface to a user for providing information to the user. The receive input component 320 receives responses from the user to queries about the type of device associated with the user. The device database 330 contains information about many types of devices that may be associated with a user, such as the distinguishing characteristics of each device. The select query component 340 determines an appropriate query to present to a user to determine the device associated with the user. For example, the select query component 340 may ask the user whether the user's mobile device has an external antenna. Based on the user's responses, the select query component 340 may dynamically determine the next question to ask the user. The select query component 340 may attempt to ask a question that is most likely to eliminate possible devices that are not the user's device.

The profile store component 350 may store information about the user's device for subsequent requests by the user. For example, the profile store component 350 may store a cookie using the user's web browser that identifies the type of the user's mobile device. The application store component 360 stores information about applications compatible with each device. The application store component 360 may also contain builds of each application for one or more types of devices. The receive purchase component 370 handles purchases from users, such as for content selected through a web site. The receive purchase component 370 may provide the user with information about how to download a purchased application or may send a link (e.g., using an SMS message) directly to the user's mobile device. More details regarding the functionality of each of these components are presented herein.

In some embodiments, the device identification system may select from many device attributes to select queries for determining the type of a user's device. These may include the mobile operator of the user's device, the manufacturer, whether the device is a flip, slide, or candy bar style, whether there is a key for each letter of alphabet, whether the device has a color screen, whether the device has a camera, where the camera is located (e.g., the front or back of the device), the operating system run by the device (e.g., Windows Mobile, Palm OS), whether the device has an external antenna, and whether the device has a touch screen. Any attribute that distinguishes one device from other devices and that is readily identifiable by a user could be used by the device identification system for determining the type of a user's device.

In one embodiments, the queries are presented to the user in the following order:
Please select the carrier you use for mobile phone service.
Do you know what company makes your phone?
Is your phone a flip phone?
   If yes, proceed to next question
   If no, ask, “Is your phone a slide phone?”
Does your phone have a built in camera?
Can you send email from your phone?
Does your phone have an external antenna?
Does your phone have a key for each letter of the alphabet?
Does your phone have a color screen?
   Based on the user's answers to these questions, the device identification system narrows down the type of the user's phone.

In some embodiments, the device identification system offers a “don't know” option for responding to a query. In some cases, a user may not have the device in front of them or for some other reason may not feel confident in the answer to a particular query. Thus, the device identification system may allow the user to skip that particular question and may choose another question to identify the user's device. For example, the user may not know the operating system used by her device, and may select “don't know” in response to a query about the operating system.

In some embodiments, the device identification system is used in conjunction with a web merchant's or other company's website. The website may offer applications, games, or other content for mobile devices, and may use the device identification system to present users with products compatible with the user's device. The website may present a user interface of the device identification system to the user before the user has selected any content so that the content can be restricted to content compatible with the user's device. For example, if the user has a Samsung D347, then the device identification system may only present applications that are compatible with that model phone to the user. Alternatively or additionally, the website may present the user interface of the device identification system to the user after the user has selected content (e.g., a particular game). For example, the user may come to the site through a search engine after searching for a particular game (e.g., Peggle), and may want to determine if the game is available for the user's device.

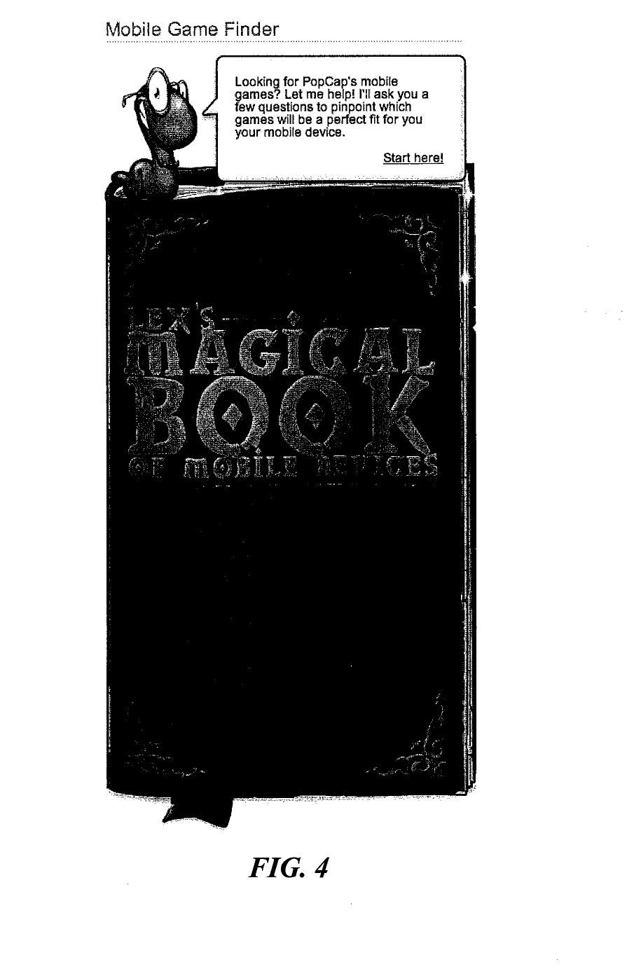

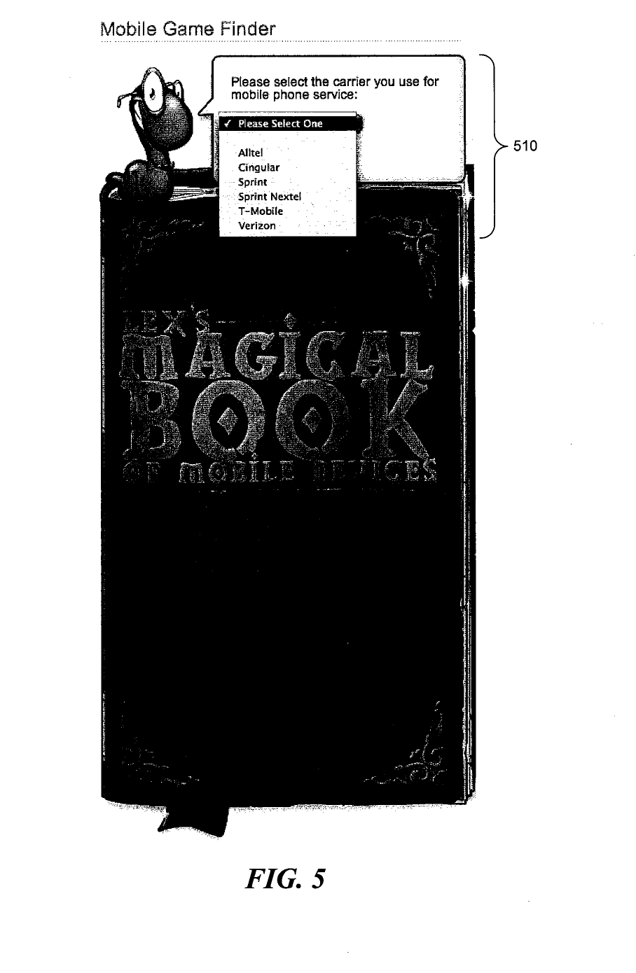

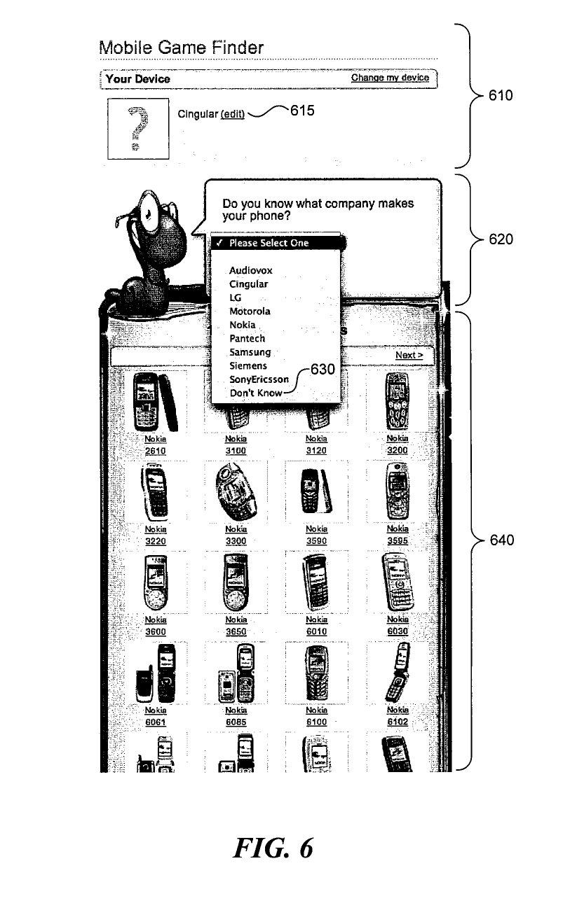

FIGS. 4-12 illustrate example display pages produced by the display user interface component of the device identification system. FIG. 4 illustrates an introductory screen in which the user is about to begin using the device identification system to identify her device. FIG. 5 illustrates a first query 510 presented to the user that asks the user the carrier used for mobile service. FIG. 6 illustrates a subsequent screen that comprises a summary of the previous queries 610, a new query 620, and a list of matching devices 640. The summary of the previous queries 610 indicates that the user answered “Cingular” to the carrier query, and provides the user with an option to modify the answer to the previous query. The new query 620 asks the user to select the manufacturer that makes the user's device. The new query 620 offers a “don't know” option 630 in case the user is unsure of the device manufacturer.

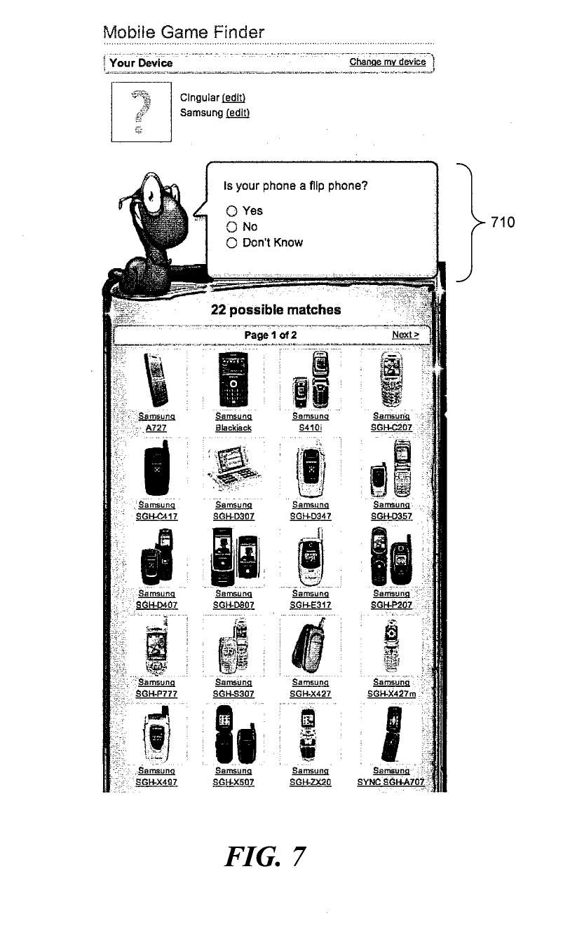

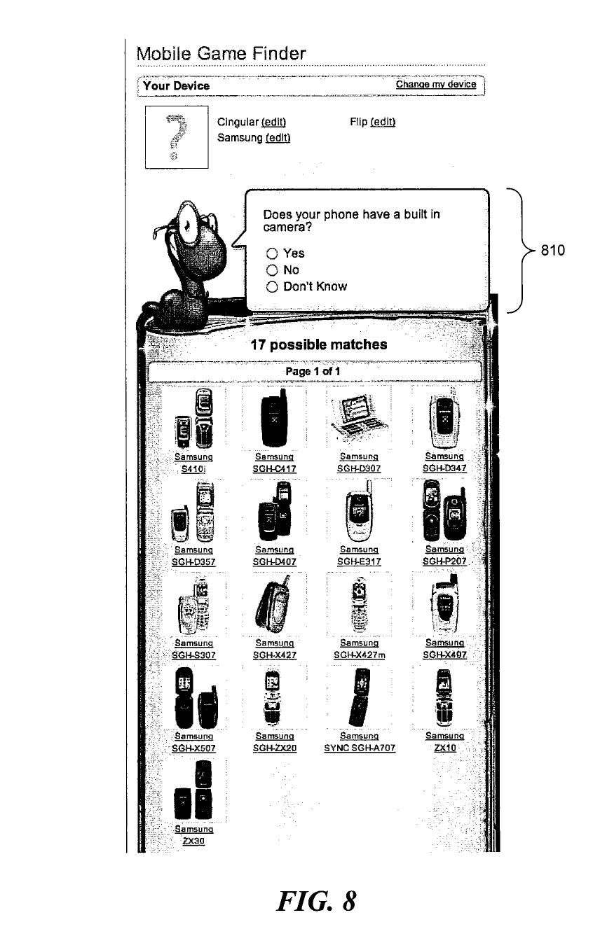

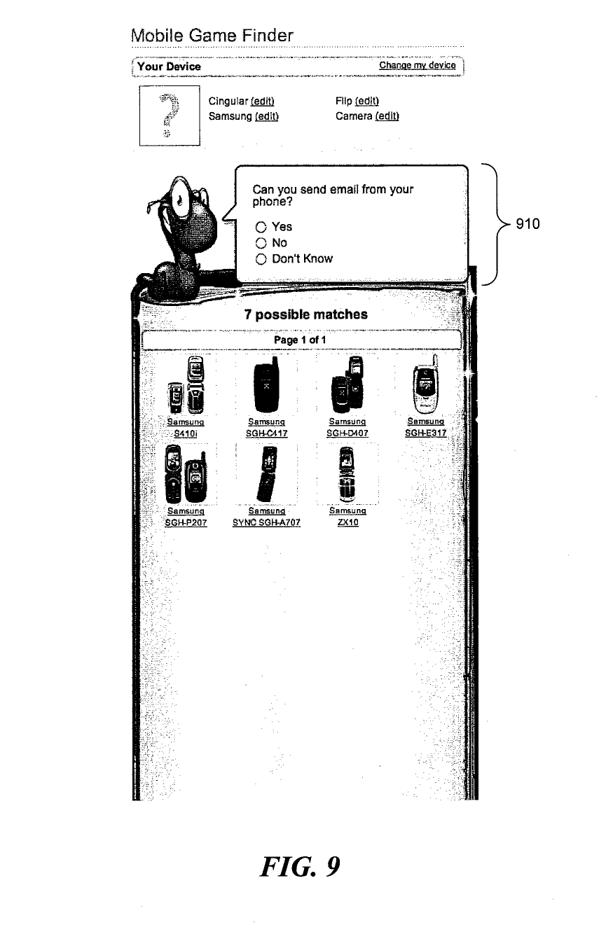

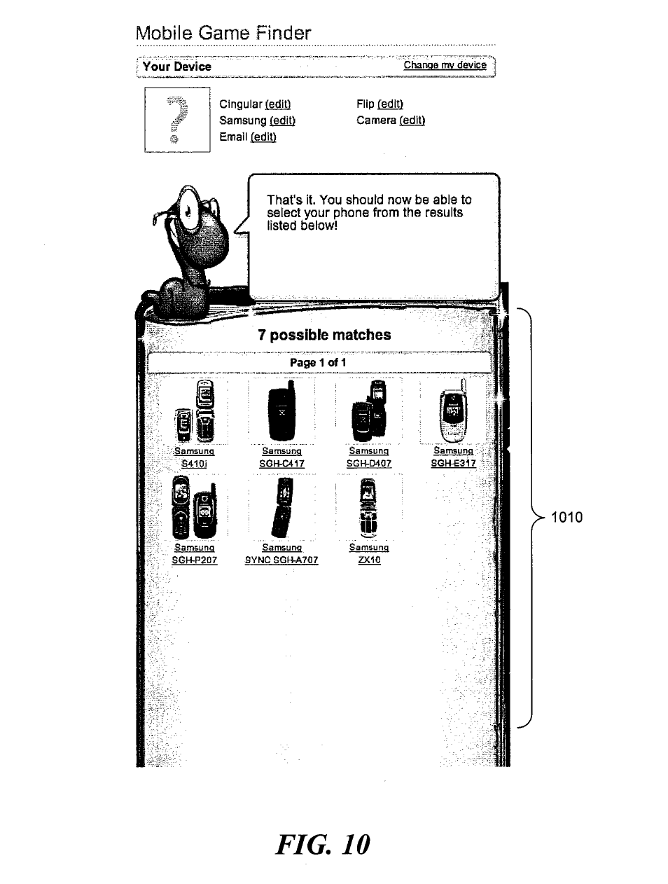

FIG. 7 illustrates a subsequent screen that contains a new query 710 that asks the user if the phone is a flip phone. FIG. 8 illustrates a subsequent screen that contains a new query 810 that asks the user if the phone has a built-in camera. FIG. 9 illustrates a subsequent screen that contains a new query 910 that asks the user if the user can send email from her phone. FIG. 10 illustrates a subsequent screen that contains displays a set of results 1010 to the user. The results 1010 have been narrowed by each successive query answered by the user, such that the results 1010 contain seven possible matches.

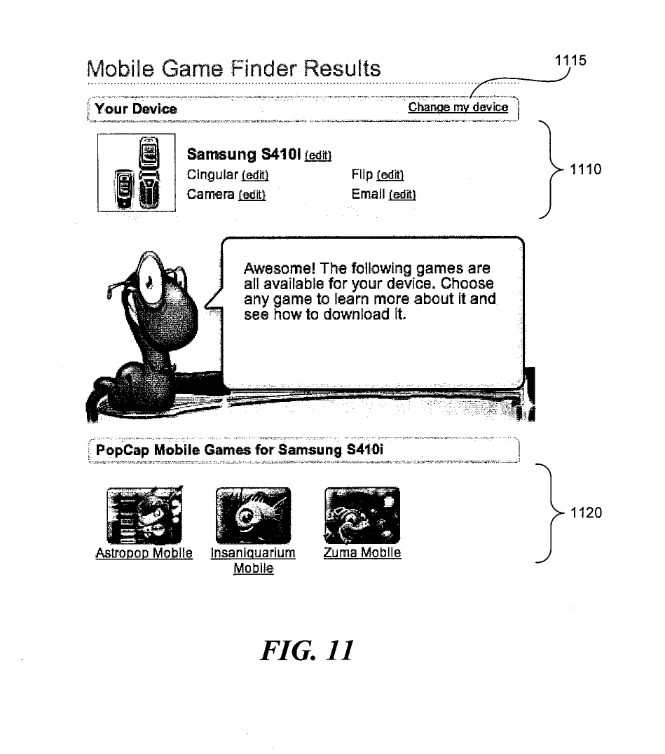

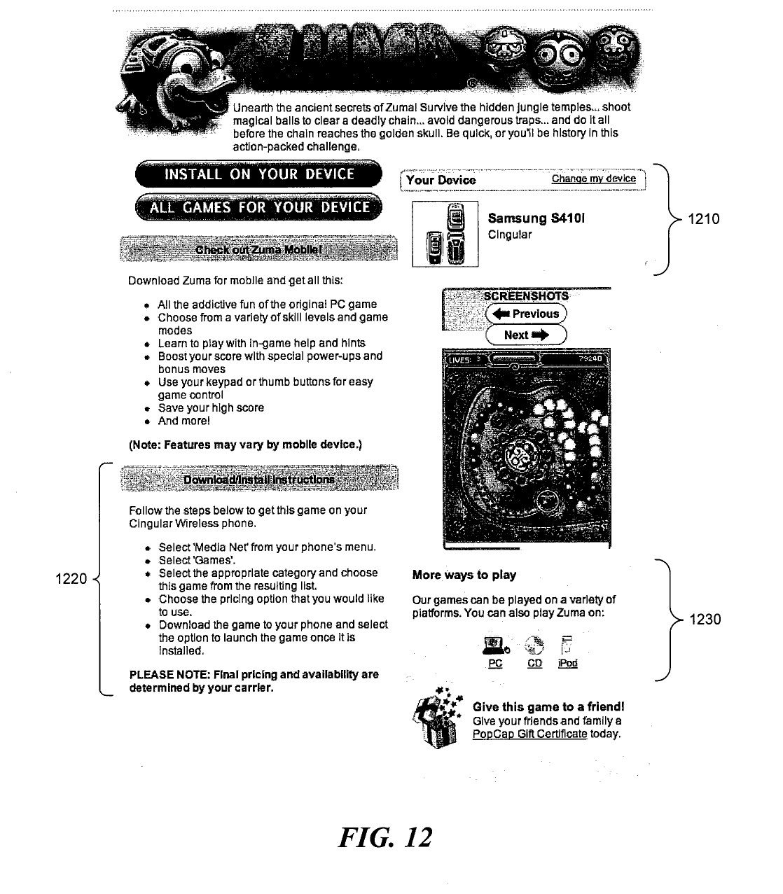

FIG. 11 illustrates a subsequent screen produced after the user has selected her device from the possible matches. The screen contains a description 1110 of the user's device, and an option 1115 to change the device if the device is incorrect. The screen also contains a list 1120 of games available for the user's specific device. The device identification system displays the screen in FIG. 12 after the user selects the game “Zuma Mobile” from the screen in FIG. 11. FIG. 12 contains a description 1210 of the user's device, instructions 1220 for downloading the game to the user's device, and other ways 1230 to play the game (e.g., on a personal computer). The instructions 1220 contain steps specific to the user's phone and carrier for obtaining the game. Thus, using the device identification system, the user can more easily identify her phone by answering common questions that the user is likely to know the answer to, and is able to more easily download applications for her device.

In some embodiments, if content selected by the user is not available for the user's device, the device identification system offers substitute content to the user. For example, a user searching for the popular game Bejeweled may be saddened to discover that Bejeweled is not available for their model of phone. However, the popular game Zuma may be available for the user's phone, and therefore the device identification system may offer the user Zuma as a substitute. Thus, the user is more satisfied with the experience of searching for games for their device and ends up with a great game to play.

In some embodiments, if content selected by the user is not available for the user's device, the device identification system suggests devices to the user that are compatible with the selected content. For example, the user may have an older device, such as the Nokia 8290, that does not support some downloadable games. Thus, the device identification system may suggest newer devices that do support the content that the user selected. In some embodiments, the operator of the device identification system may determine which devices to offer based on promotional agreements with phone carriers.

In some embodiments, the device identification system stores the type of the user's device for subsequent visits. For example, the device identification system may store the type of the user's device in a cookie associated with the user's web browser or in a profile associated with the user. The next time the user visits the web site, the device identification system determines the user's device based on the stored information and does not need to re-query the user.

In some embodiments, the device identification system may show an indication of matching devices as the user progresses through one or more queries. Users often feel more comfortable completing a process when there is an indication that the process is achieving the user's goals. Thus, by showing the user an indication, such as a count or list, of devices that currently could be the user's device, and narrowing the indication as the user answers queries, the device identification system provides the user with a sense of progress toward the user's goal of identifying his device. Alternatively or additionally, if a list is presented the user may at any time select her phone from the list when the choices become sufficiently narrow without responding to additional queries.

In some embodiments, the device identification system uses the determined device to provide the user with instructions for downloading selected content. For example, the user may be using a mobile device operator or wireless service provider that only allows receiving new content through that operator. A user visiting a web merchant's site may find a game that the user would like, but not know how to receive the game on her phone. Thus, the device identification system may determine the user's device and provide the user with specific instructions for downloading the selected game to her phone. Alternatively or additionally, the device identification system may provide the user with a deep link to a specific web page within the operator's web site and instructions indicating how to download the game there to save the user from having to dig through the operator's web site to find this information.

In some embodiments, the device identification system sends a link to selected content to the user's mobile device. For example, some devices can receive content through links contained in Short Message Service (SMS) messages, via email, or directly through a browser over the Internet. Based on the user's responses to device related queries, the device identification system can send a link specific to the user's type of device. For example, if the content is a game and a different build is required based on the platform of the user's device, then the device identification system can send a link for the specific build appropriate for the user's device. Some devices, such as smart phones, allow the user to insert the device in a docking cradle and download applications using a personal computer (PC). The device identification system may send links or the content itself to the user's PC that allow the user to download and install the applications to her mobile device through the docking cradle.

In some embodiments, the device identification system depends on the mobile phone operator to send the correct link for selected content to the user. For example, some mobile operators do not require knowledge of the user's type of device before sending an SMS message to download a game. Thus, once the mobile phone operator is known, the device identification system can skip certain queries related to the device type and forward the user's request for content directly to the mobile phone operator. The mobile phone operator then sends the user a link to the appropriate content for the user's device.

In some embodiments, the device identification system displays multiple queries simultaneously. Rather than presenting queries to the user in series, the device identification may display several (e.g., three) queries at the same time. This reduces the feeling that the user is going through a long interview by reducing the number of screens that the user sees. In many cases, the user may be able to find their device after answering a single display of several questions.

The device identification system may display the determined device to the user in subsequent displays after the device identification system has determined the user's device type. Users are wary about searching for content only to find out that no content is available for their particular device. By repeatedly reinforcing that the site is aware of the user's type of device, the device identification system increases the user's confidence to search for additional confidence. Thus, because the user knows that they will find an application that works for his device, he is more likely to buy more content or spend more time browsing the web site.

In some embodiments, the device identification provides a reset link to indicate that the type of the user's phone is incorrect. For example, if the user purchases a new phone, a web site using the device identification system may provide a “change phone” link that the user can activate to repeat the device identification process and determine the type of the user's new device.

The device identification system may use stored information about the user's device type to provide marketing information to the user. For example, when the user visits a web merchant's site to purchase a game for his PC, if the web merchant also offers a mobile version of the game that is compatible with the user's mobile device, the web merchant may offer the mobile version of the game as part of the purchase. The web merchant may charge an additional fee for the mobile version or include the game free.

In some embodiments, the operator of the device identification system may provide their own branded phone. For example, when a user cannot find a game for his phone, the device identification system may display an offer to the user to purchase a phone compatible with the operator's web site. The phone may be preloaded with content from the operator, such as games, applications, and so on.

In some embodiments, the device identification system uses stored information about users' devices for statistical purposes. For example, the device identification system may provide a report to mobile operators indicating the most popular types of devices, or content that users selected but were unable to obtain because of the type of their devices or restrictions imposed by the carrier. In some embodiments, mobile operators may bid with a web merchant for placement as a suggested replacement for devices that do not support popular content. For example, if a web merchant offers a downloadable game, but users having an older phone cannot play the game, the web merchant may suggest a particular updated phone model or particular mobile operator that is compatible with the selected content.

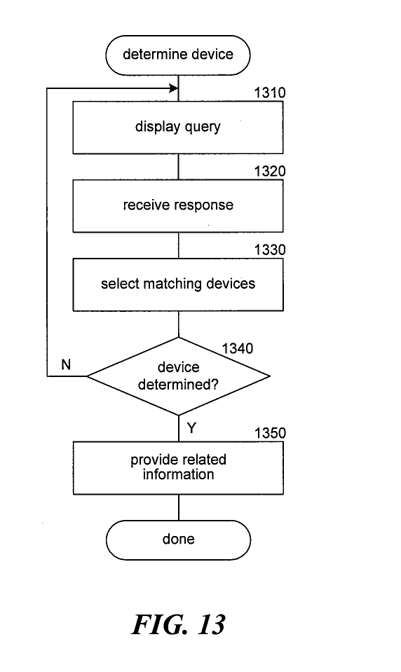

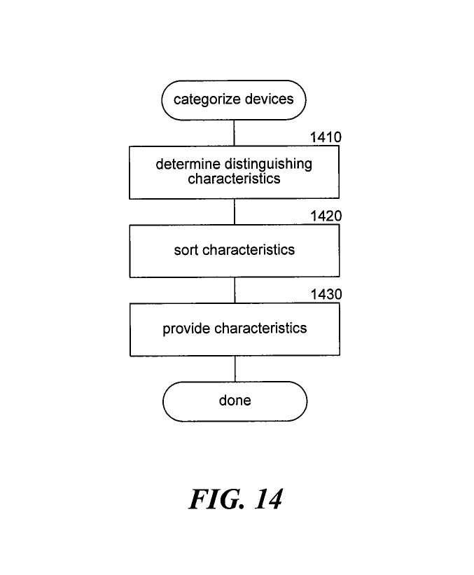

FIGS. 13-14 are representative flow diagrams that depict processes used in some embodiments. These flow diagrams do not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented.

FIG. 13 is a flow diagram that illustrates one example of the processing of the components of the system to determine the type of a user's device. In block 1310, the component displays a query to the user that describes an attribute of a mobile device. For example, the query may ask whether the user's device is a flip phone. In block 1320, the component receives a response from the user based on the query. In block 1330, the component selects devices that match the received response and any previously received responses. For example, if the user indicated that his device is a flip phone, then the component provides a list of flip phones and removes devices that are not flip phones. In decision block 1340, if the user's device has been determined, then the component continues at block 1350, else the component loops to block 610 to display additional queries. In block 1350, the component provides information related to the determined devices. The component may not present additional queries to the user once the number of possible devices is small (e.g., five), and may present the user with images of the devices to select from instead. After block 1350, the component completes.

FIG. 14 is a flow diagram that illustrates one example of the processing of the select query component of the device identification system. The component is invoked to select the order of queries presented to the user. The component may invoked prior to receiving any user queries to determine an order that queries will be presented, or may be invoked dynamically to determine an order based on the user's responses to previous queries. In block 1410, the component determines the distinguishing characteristics of devices. For example, the component may inspect a database of device information to determine characteristics that distinguish one device from another. In block 1420, the component sorts the characteristics based on the level of distinction that the characteristic provides. For example, the component may determine that device color does not distinguish very many devices from one another and therefore the component may sort color lower than another characteristic. In block 1430, the component provides the query order based upon a request. After block 1430, the component completes.

### CONCLUSION

From the foregoing, it will be appreciated that specific embodiments of the device identification system have been described herein for purposes of illustration, but that various modifications may be made without deviating from the spirit and scope of the invention. For example, although mobile phones have been used by way of example, other mobile devices can be used with the device identification system such as PDAs, portable gaming devices, smart phones, smart watches, and so on. In addition, although games are used by way of example, other content such as ring tones, applications, and other types of content may be used with the system. Accordingly, the invention is not limited except as by the appended claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. In addition, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A method in a computer system for determining the type of a device associated with a user, the method comprising:
displaying queries to the user describing characteristics of multiple devices;
receiving from the user one or more responses to the queries;
determining the type of the device associated with the user based on the received responses; and
providing the user with information related to the determined device.

2. The method of claim 1 wherein the information is a downloadable game.

3. The method of claim 1 wherein the information comprises instructions for downloading an application for the device.

4. The method of claim 1 including gathering statistics about the determined devices of multiple users.

5. The method of claim 1 including selecting a build of an application based on the determined device.

6. The method of claim 1 including determining at least one application among a group of applications that is compatible with the determined device.

7. The method of claim 1 including notifying the user when a new application is available for the determined device.

8. The method of claim 1 including storing information about the determined device in a profile associated with the user.

9. The method of claim 1 including sending the user a message with a link to an application based on the determined device.

10. The method of claim 1 including receiving a request for an application from the user and when the application requested by the user is not available for the determined device, providing information to the user about a substitute application.

11. The method of claim 1 including receiving a request for an application from the user and when the application requested by the user is not available for the determined device, providing information to the user about another device for which the application is available.

12. A computer-readable medium encoded with instructions for controlling a computer system to categorize mobile devices by characteristics, by a method comprising:
determining one or more characteristics that distinguish one mobile device from other mobile devices in a group of multiple devices;
sorting the characteristics to determine more distinguishing characteristics; and
providing the characteristics in response to a request from a decision support system wherein the characteristics are provided in an order related to how well each characteristic distinguishes one mobile device from other mobile devices,
such that queries based on the distinguishing characteristics can be used to determine the type of a device associated with a user.

13. The computer-readable medium of claim 12 including providing information about an application compatible with each device in the group in response to a request from a decision support system.

14. The computer-readable medium of claim 12 wherein sorting the characteristics comprises determining how many devices match a particular characteristic when the characteristic has a particular value.

15. The computer-readable medium of claim 12 wherein sorting the characteristics comprises determining an order that requires the fewest number of questions to identify the type of the device associated with the user.

16. A system for providing information about an application for a mobile device associated with a user, comprising:
a purchase receiving component configured to receive a request to purchase an application for a first device associated with the user;
a profile store component configured to identify based upon a profile associated with the user a mobile device other than the first device associated with the user; and
a user interface display component configured to display to the user information about an application for the mobile device related to the application for the first device.

17. The system of claim 16 wherein the application for the mobile device is a build of the application for the first device that is compatible with the mobile device.

18. The system of claim 16 wherein the applications are games.

19. The system of claim 16 wherein the profile store component stores a cookie with a browser associated with the user.

20. The system of claim 16 wherein the purchase receiving component receives the request to purchase through a web site of a web merchant.
